(19) United States
(12) Patent Application Publication
(10) Pub. No.: US 2023/0177238 A1
(43) Pub. Date: Jun. 8, 2023

(54) METHOD OF IMPLEMENTING WIND FIELD IN WEB BROWSER USING GRAPHIC CARD COMPUTING POWER

(71) Applicant: GAIA3D, Inc., Seoul (KR)

(72) Inventors: Seong Do SON, Seoul (KR); Hak Jun KIM, Seoul (KR)

(21) Appl. No.: 18/074,648

(22) Filed: Dec. 5, 2022

(30) Foreign Application Priority Data
Dec. 8, 2021 (KR) 10-2021-0175061

(51) Int. Cl. G06F 30/20; G01P 5/00

(52) U.S. Cl. CPC G06F 30/20; G01P 5/00

(57) ABSTRACT

The invention relates to method for simulating wind fields in a web browser using the computing power of a graphics card, the method comprising: obtaining wind field data, uploading the wind field data, freeing up a memory space, saving a first position of a particle, determining a second position of the particle, updating the position of the particle and visualizing a wind flow marker.

### CROSS-REFERENCE TO RELATED APPLICATIONS

This application claims priority to Korean Patent Application No. 10-2021-0175061, filed on Dec. 08, 2021. The entire disclosure of the application identified in this paragraph is incorporated herein by reference.

### TECHNICAL FIELD

The invention relates to a method for simulating wind fields in a web browser using the computing power of a graphics card.

### BACKGROUND

This section provides background information related to the present disclosure which is not necessarily prior art.

For years, research on techniques for obtaining weather data such as wind flow, temperature, an amount of water vapor etc., using weather monitoring systems, to analyze the weather data obtained and forecast weather conditions has been actively carried out. In this regard, there is a growing interest in a method for visualizing and displaying weather data that shows weather conditions.

People are also turning their attention to a user interface that incorporates visualized weather information into a virtual terrain model. However, the conventional user interfaces simply display the weather information collected, and do not necessarily present any other observations or predictions related to weather in an effective manner.

FIG. 1 is a schematic view illustrating a prior art method for displaying wind fields, as described in Korean Patent Registration No. 10-1653747 (Aug. 29, 2016).

While the prior art technique displays wind fields in a web browser by way of image blending, it has an issue with continuity. Here, for example, wind marker images that are to be shown on the screen are blended with spatial information images that are also to be shown on the screen. If a user wants to move or zoom-in/zoom-out the screen or to change the camera angle, etc., however, he/she must erase all wind marker images that had been drawn previously and recreate or redraw new images with modified opacity. Thus, it can often be challenging to ensure continuity with this method.

### SUMMARY

The invention is specified in the below description.

This section provides a general summary of the disclosure and is not a comprehensive disclosure of its full scope or all of its features.

The invention is directed to provide a method for simulating wind fields in a manner that wind flow marker points are directly drawn in a three-dimensional space, so as to ensure continuity.

In one aspect, the invention provides a method for simulating wind fields in a web browser using the computing power of a graphics card, comprising: obtaining wind field data by receiving raw weather information from a weather monitoring system to obtain the wind field data from the received weather information; uploading the wind field data to a graphic card; freeing up a memory space for a particle position storage array, where the positions of particles are to be saved; saving a first position of a particle by randomly placing a particle on a wind field to determine its first position and saving the first position in a current position section of the particle position storage array; determining a second position of the particle by calculating a second position of the particle from the first position of the particle using the wind field data therein; updating the position of the particle by updating the second position of the particle to the current position and saving the second position of the particle in the current position section of the particle position storage array, while saving the first position of the particle in a 1-frame preceding position section of the particle position storage array; and visualizing a wind flow marker by using the updated particle position storage array to visualize wind flow markers of particles on the screen.

The wind field simulation method of the invention is advantageous in that it visualizes wind flow markers on the screen, while maintaining continuity even when the screen has shifted or zoomed-in/zoomed-out or the camera angle has been changed.

### BRIEF DESCRIPTION OF THE DRAWINGS

FIG. 1 schematically illustrates a prior art method for displaying wind fields.

FIG. 2 is a flow chart schematically describing one embodiment of a method for simulating wind fields in a web browser using the computing power of a graphics card, according to the invention.

FIG. 3 schematically illustrates a method for locating a particle in an animation frame within a wind field, according to the invention.

FIGS. 4A and 4B schematically illustrate an animation method of a wind flow marker, according to the invention.

FIG. 5 schematically illustrates a wind field visualization process according to the invention.

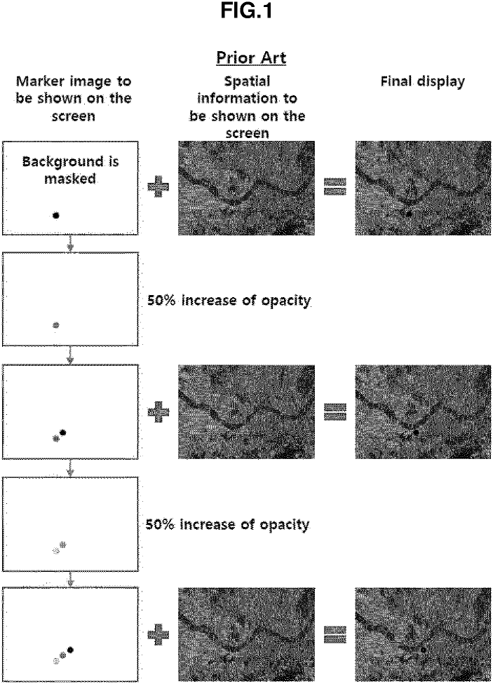

### DETAILED DESCRIPTION

The present disclosure will now be described in detail with reference the accompanying drawing(s).

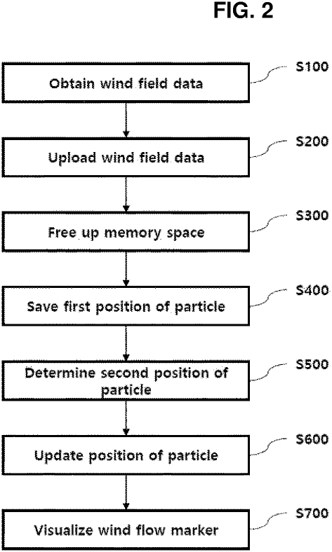

FIG. 2 illustrates one embodiment of the invention, in which a method for simulating wind fields in a web browser using the computing power of a graphics card is described in a flow chart.

As can be seen from FIG. 2, the method may comprise the steps of: obtaining wind field data (S100), uploading the wind field data (S200), freeing up a memory space (S300), saving a first position of a particle (S400), determining a second position of the particle (S500), updating the position of the particle (S600) and visualizing a wind flow marker (S700).

In the step of obtaining wind field data (S100), raw weather information is received from a weather monitoring system and wind field data is then obtained from the weather information.

Raw weather information may include data such as temperature, wind, atmospheric pressure, reflectivity, albedo, dew point, humidity, clouds, sea wind, etc. In the context of the invention, the raw weather information refers to wind data of any wind relevant characteristics. The wind data included in the raw weather information may have wind vector components x and y (u, v) recorded in a lattice form, which are herein referred to as wind field data.

In the step of uploading wind field data (S200), the wind field data is uploaded to a graphics card. As the wind field simulation method of the invention requires higher computing power than any conventional method of displaying wind fields by image blending, using a graphics card for computing the position of a wind flow marker (as described in more detail below) is advantageous for resolving such a high power requirement issue. Typically, a graphics card having thousands of to tens of thousands of computing units can demonstrate a very strong computing power for parallel processing of array value calculations.

In the step of freeing up a memory space (S300), a memory space is made available for a particle position storage array, where the positions of particles are to be saved. With the graphics card being responsible for computing the position of a wind flow marker in the invention, it is necessary to secure the memory space for the graphics card in relation to the particle position storage array where positions of particles are to be saved.

In the step of saving a first position of a particle (S400), a particle is randomly placed on a wind field to determine its first position, and this first position of the particle is then saved in a current position section of the particle position storage array. That is, a particle corresponding to a certain wind flow marker is randomly placed on a wind field based on the wind field data that had been uploaded to a graphics card, and an initial position of the particle is set as its first position. Once the first position of the particle is determined, it is saved in the ‘current’ position section in the particle position storage array where positions of particles are to be saved.

In the step of determining a second position of the particle (S500), a second position of the particle is calculated from the first position of the particle using the wind field data therein.

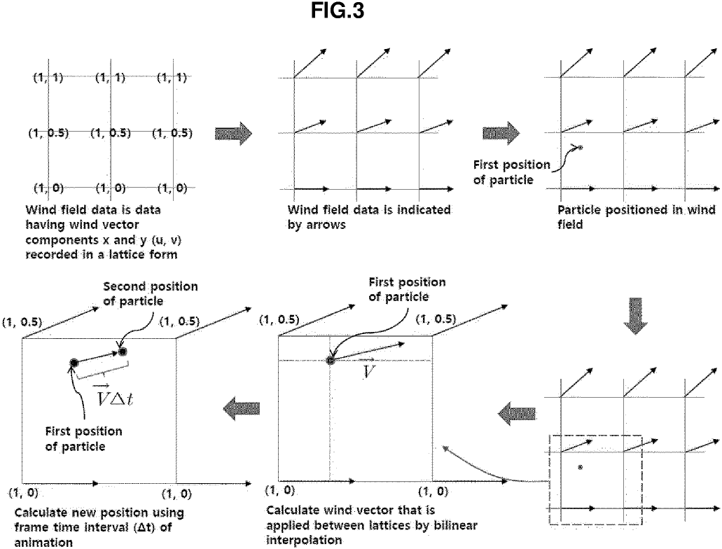

FIG. 3 schematically illustrates a method for locating a particle in an animation frame within a wind field, according to the invention.

Referring to FIG. 3, after obtaining wind field data of which wind vector components x and y (u, v) are recorded in a lattice form, the wind field data can be indicated by arrows. A particle corresponding to a certain wind flow marker is randomly placed on the wind field to determine its first position. If this first position of the particle lies between lattices, a wind vector that is applied between lattices can be calculated by bilinear interpolation. A second position of the particle is then calculated from the first position of the particle using the wind field data in this first position. In particular, a second position of the particle can be calculated from the first position of the particle using a frame time interval (Δt) of the animation that visualizes a corresponding wind flow marker.

In further embodiments of a method for simulating wind fields in a web browser using the computing power of a graphics card according to the invention, the step of determining a second position of the particle (S500) includes calculating a second position of the particle using a frame time interval (Δt) of animation used for the visualization of a corresponding wind flow marker.

In the step of updating the position of the particle (S600), the newly calculated second position of the particle is updated to the current position and saved in a current position section of the particle position storage array. Thereafter, the first position of the particle is saved in a 1-frame preceding position section of the particle position storage array, such that the position of the particle after the frame time interval (Δt) of the animation may be updated.

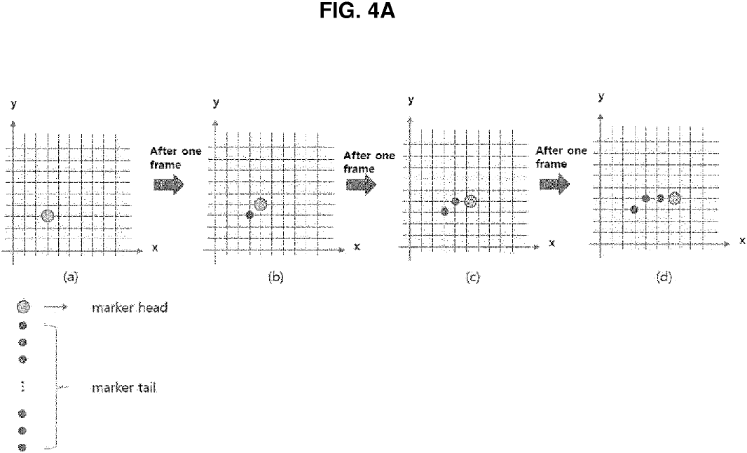

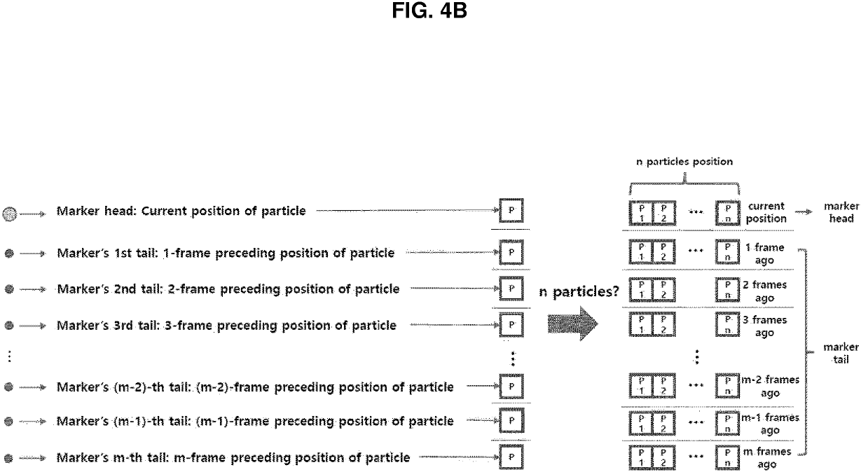

FIG. 4 schematically illustrates an animation method of a wind flow marker, according to the invention. In particular, FIG. 4A illustrates an animation method for one particle, and FIG. 4B illustrates an animation method for n particles.

Referring first to FIG. 4A, in (a), a first position of a particle is determined and in (b), a second position of the particle is determined after one frame. Here, the second position of the particle becomes the head of a wind flow marker, and the first position of the particle becomes the tail of a wind flow marker. Then, again in (c), a third position of the particle is determined after one frame. At this time, the third position of the particle becomes the new head of a wind flow marker, and the second position of the particle followed by the first positions of the particle become the tail of a wind flow marker. These steps can be repeated such that a wind flow marker is visualized, looking like a flowing particle.

Turning now to FIG. 4B, animation for n particles can be simulated.

A wind flow marker herein is a symbol having the shape of a particle flowing in the air, so as to show the flow of wind in a dynamic animation. With the head and tail being configured for a wind flow marker, the afterimage effect can be enhanced.

As well known, animation herein refers to a process by which a number of still images are presented in quick enough succession that the human eye cannot perceive, making them appear as a continuous moving image. Accordingly, by updating positions of wind flow markers for every frame and presenting them on the screen, the wind flow markers will be visualized, appearing as flowing particles to the viewer.

Finally, in the step of visualizing a wind flow marker (S700), an updated particle position storage array is used to visualize a wind flow marker of the corresponding particle.

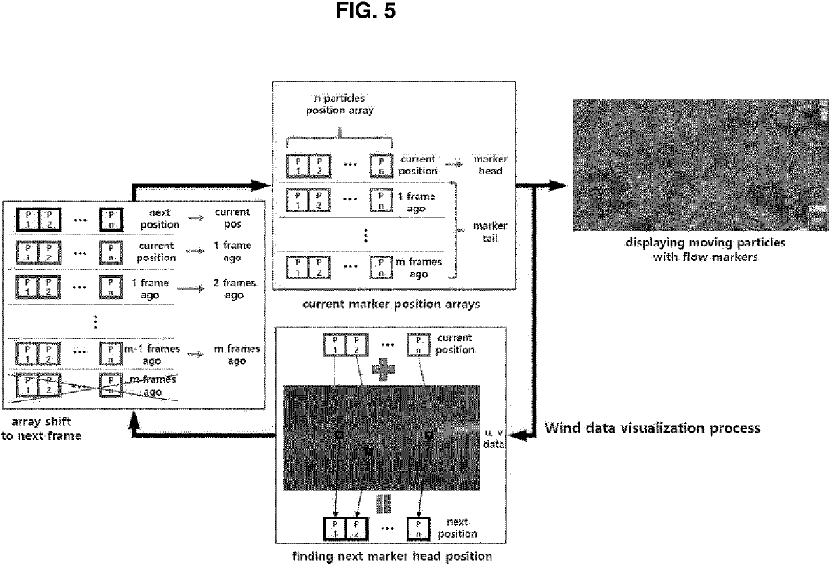

FIG. 5 schematically illustrates a wind field visualization process according to the invention.

As can be seen from FIG. 5, with positions of wind flow markers being kept updated for every frame and presented on the screen, the wind flow markers can be visualized, appearing as flowing particles to the viewer.

In further embodiments of a method for simulating wind fields in a web browser using the computing power of a graphics card according to the invention, the step of freeing up a memory space may include securing a memory space for N × (M+1) arrays where positions of N particles for (M+1) frames are to be saved.

Referring back to FIG. 4B, to simulate animation of (M+1) frames for N particles, a memory space for N × (M+1) arrays is required. In other words, the step of freeing up a memory space may comprise securing a memory space for N × (M+1) arrays.

In further embodiments of a method for simulating wind fields in a web browser using the computing power of a graphics card according to the invention, the step of determining a second position of the particle and the step of updating the position of the particle may be carried out iteratively in order to determine a third position of the particle.

As discussed previously with reference to FIGS. 3 and 4, the position of a wind flow marker is being kept updated for every frame so that the head and tail of the wind flow marker are updated to the latest position of a corresponding particle and presented on the screen, which renders a visualized wind flow marker appearing as a flowing particle to the viewer.

Hereinafter, various embodiments of the present disclosure will be described below.

(1) A method for simulating wind fields in a web browser using the computing power of a graphics card, comprising: obtaining wind field data by receiving raw weather information from a weather monitoring system to obtain the wind field data from the received weather information; uploading the wind field data to a graphic card; freeing up a memory space for a particle position storage array, where the positions of particles are to be saved; saving a first position of a particle by randomly placing a particle on a wind field to determine its first position and saving the first position in a current position section of the particle position storage array; determining a second position of the particle by calculating a second position of the particle from the first position of the particle using the wind field data therein; updating the position of the particle by updating the second position of the particle to the current position and saving the second position of the particle in the current position section of the particle position storage array, while saving the first position of the particle in a 1-frame preceding position section of the particle position storage array; and visualizing a wind flow marker by using the updated particle position storage array to visualize wind flow markers of particles on the screen.

(2) In the method for simulating wind fields in a web browser using the computing power of a graphics card, the step of freeing up a memory space comprises securing a memory space for N × (M+1) arrays where positions of N particles for (M+1) frames are to be saved.

(3) In the method for simulating wind fields in a web browser using the computing power of a graphics card, the step of determining a second position of the particle and the step of updating the position of the particle are carried out iteratively in order to determine a third position of the particle.

(4) In the method for simulating wind fields in a web browser using the computing power of a graphics card, the step of determining a second position of the particle comprises calculating a second position of the particle using a frame time interval (Δt) of animation used for the visualization of a corresponding wind flow marker.

What is claimed is:

1. A method for simulating wind fields in a web browser using the computing power of a graphics card, comprising:
obtaining wind field data by receiving raw weather information from a weather monitoring system to obtain the wind field data from the received weather information;
uploading the wind field data to a graphic card;
freeing up a memory space for a particle position storage array, where the positions of particles are to be saved;
saving a first position of a particle by randomly placing a particle on a wind field to determine its first position and saving the first position in a current position section of the particle position storage array;
determining a second position of the particle by calculating a second position of the particle from the first position of the particle using the wind field data therein;
updating the position of the particle by updating the second position of the particle to the current position and saving the second position of the particle in the current position section of the particle position storage array, while saving the first position of the particle in a 1-frame preceding position section of the particle position storage array; and
visualizing a wind flow marker by using the updated particle position storage array to visualize wind flow markers of particles on the screen.

2. The method according to claim 1, wherein the step of freeing up a memory space comprises securing a memory space for N x (M+1) arrays where positions of N particles for (M+1) frames are to be saved.

3. The method according to claim 1, wherein the step of determining a second position of the particle and the step of updating the position of the particle are carried out iteratively in order to determine a third position of the particle.

4. The method according to claim 1, wherein the step of determining a second position of the particle comprises calculating a second position of the particle using a frame time interval (Δt) of animation used for the visualization of a corresponding wind flow marker.
